(19) United States
(12) Patent Application Publication
(10) Pub. No.: US 2025/0250790 A1
(43) Pub. Date: Aug. 7, 2025

(54) A FIRESTOP DEVICE

(71) Applicant: POLYSEAM LIMITED, Huddersfield (GB)

(72) Inventors: Duncan ALABASTER, Huddersfield (GB); Kjetil BOGSTAD, Huddersfield (GB); David ALLEN, Huddersfield (GB); Wol HLUCHAN, Huddersfield (GB)

(21) Appl. No.: 18/695,044

(22) PCT Filed: Oct. 3, 2022
(86) PCT No.: PCT/GB2022/052498

§ 371 Date: Mar. 25, 2024

(30) Foreign Application Priority Data
Oct. 7, 2021 (GB) 2114390.4

(51) Int. Cl. E04B 1/94

(52) U.S. Cl. CPC E04B 1/947

(57) ABSTRACT

A firestop device comprising two opposed faces A, B, and an intermediate passage defining an axis C for passage of elongate objects (100), wherein the passage forms part of a hole through two sides of a structure D, and a displaceable barrier 3, 31 is located between the faces; and wherein the barrier 3, 31 is rotated about the axis C to change the diameter of the passage.

### FIELD OF THE INVENTION

The present invention relates to a firestop device, in particular a device for stopping the spread of smoke between zones; more particularly but not exclusively a device for preventing spread of smoke through passages for cabling or the like.

### BACKGROUND AND PRIOR ART

Increasing awareness of fire and smoke dangers is a factor in many societies, in relation to many environments, for example built environments such as commercial and domestic properties.

In particular passage of smoke through various zones within a property can lead to high dangers for inhabitants.

As a result many properties are built with stringently enforced building compliances measures, such as intumescent smoke seals around doorways, as well as fire resistant hardware and barriers. A firestop or fire-stopping is a form of passive fire protection that is used to seal around openings and between joints in a fire-resistance-rated wall or floor assembly. Firestops are intended to maintain fireproofing of a wall or floor assembly and impede the spread of fire and smoke.

However it can be problematic to restrict or prevent all smoke passage through barriers from one zone to another. Smoke may be capable of passing through smaller holes that may link zones in a property.

For example, in many properties in many societies in many different forms of occupancy, there may often exist significant infrastructure passing between otherwise sealed or sellable zones of a property.

For example in many properties, significant numbers of pipes, plumbing or otherwise, and/or wires, electrical or networking, may be expected and required to pass from one zone to another.

Typically these pipes or wires or cables may be envisaged to pass through zones in separate or sealed spaces, for example within fire retardant boxing. However this can mean that such piping or cabling is difficult to access for maintenance or renewal purposes, for example in datacentres or similar mass occupancy high-tech properties.

The present invention arose in order to overcome problems suffered by existing devices.

### SUMMARY OF THE INVENTION

According to the present invention there is provided a firestop device comprising a two opposed faces, and an intermediate passage defining an axis for passage of elongate objects, wherein the passage forms part of a hole through two sides of a structure, and a displaceable barrier is located between the faces; and wherein the barrier is rotated about the axis to change the diameter of the passage.

In some embodiments the elongate members may be envisaged to comprise cabling, for example a bundle of cables.

In this way the device of the present invention may be enabled to be rotated so as to close the passage, in particular around the cabling or other elongate members.

The barrier may be envisaged to be formed in a fire-resistant material. In some embodiments the material of the barrier may be envisaged to be Kevlar® or similar.

Closure of the passage around the cabling may in turn be envisaged to advantageously create a cold smoke barrier around the cabling so as to prevent as much air as possible from passing from one zone to another.

In some embodiments the device is envisaged to be used on one side of a structure, around a hole through the structure. In this way a face may be in contact with the structure, around the hole for example, and the other face may be envisaged to be spaced apart from the hole, whereby the passage comprises an external extension to the hole in use.

In some embodiments the faces are arranged in use to be located on either side of a hole through a structure. For example the device in general may be wholly or substantially outwith the hole and structure. The device may be mounted by a mounting means to the structure around the hole, and it may be envisaged that the mounting means may be envisaged to provide a seal, for example including screws and/or sealant or adhesive.

In this way the passage may be envisaged to be synonymous with the hole in the structure, and may line such hole for example.

In some embodiments the barrier may be located outside the hole, and in other embodiments the barrier may be located within the hole and structure.

In some embodiments the device in use may be envisaged to be placed over a pipe protruding from a wall, and will sit flush with the wall, for example providing a collar around the pipe, which pipe forms the hole. An intumescent seal may be added between the collar or base plate and the wall and/or pipe, and the base plate may be screwed to the wall in addition or the alternative.

A face plate may be placed over this base plate or collar, which face plate may be metal or alloy and arranged to clip fit on the base plate so as to cover fixings.

The base plate may provide an upstanding collar part, which collar part may support a rotatable lock part, which lock part may comprise an annular part with a locking configuration, arranged to lock onto a catch means located on the base plate or a part connected thereto. The locking part may be envisaged to connect with or grip over or onto the barrier, such that the rotation of the lock part rotates the barrier, and the lock part's engagement with the catch means prevents counter-rotation of the barrier. In this way the barrier may be rotated as desired in order to enlarge or reduce a central perforation, where the barrier is arranged to twist and open or close like a lens diaphragm, during rotation.

In some embodiments for example a fabric sleeve may be placed into a grooved track locking ring, which track is placed on the back plate, so as to require a part to flex and snap into the thin grooves whereby slight spring in the metal should allow for this action and the locking ring can now slide onto and will buffer up to the end of the backing plate where teeth on the ring engage notches on the plate.

In some embodiments the lock part may be resiliently deformable or spring biased.

A preferred embodiment of the invention will now be described by way of example only and with reference to the Figures in which:

### BRIEF DESCRIPTION OF FIGURES

FIG. 1 shows a sketch of an isometric view of an embodiment of the device according to the present invention in use, on a pipe, with cabling;

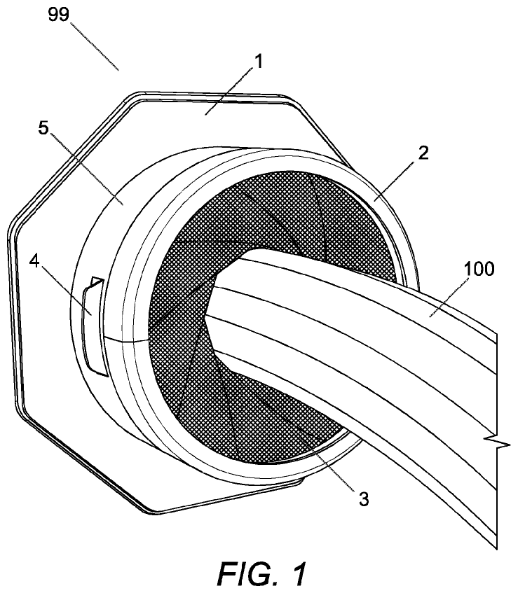

FIG. 2 shows a sketch of an exploded isometric view of the embodiment of the device shown in FIG. 1;

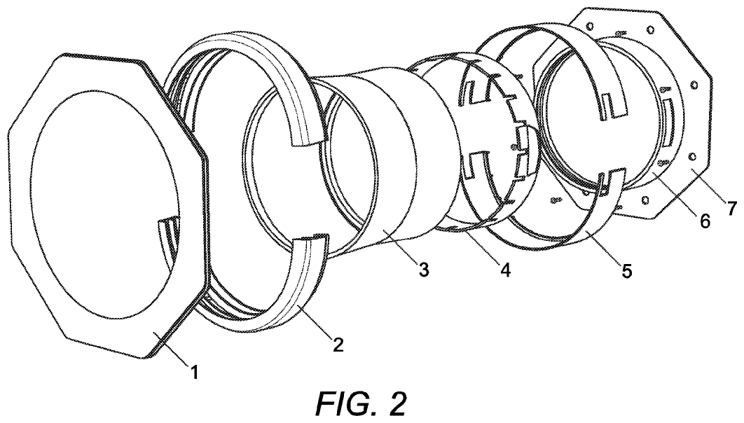

FIG. 3 shows a sketch of a sectional view of the embodiment of the device shown in FIG. 1, on the pipe;

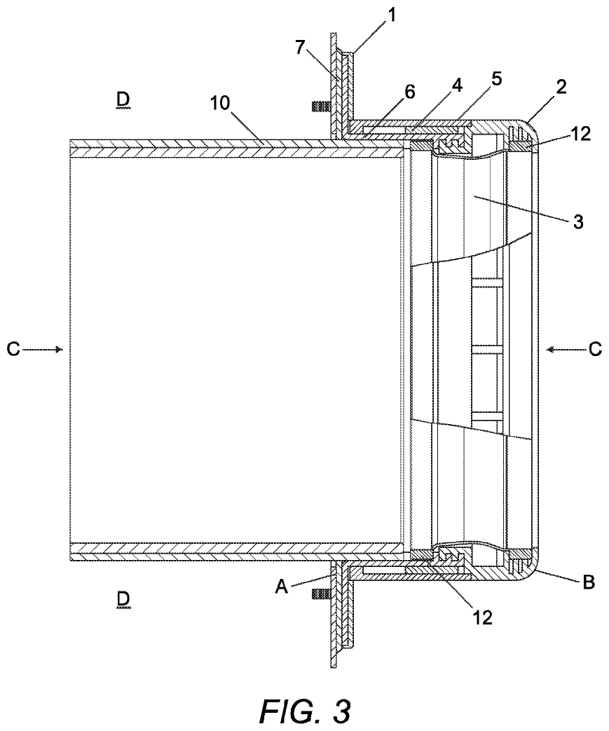

FIG. 4 shows a sketch of a side view of the embodiment of the device shown in FIG. 1, on the pipe;

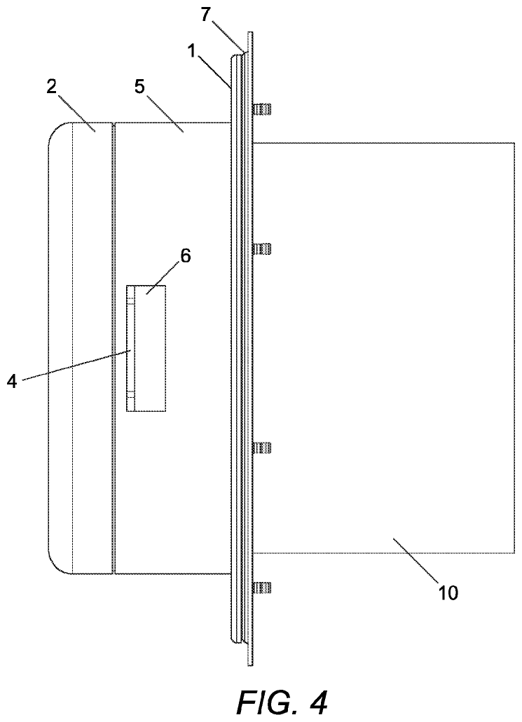

FIG. 5 show stages of use of the embodiment of the device as shown in FIG. 1;

FIG. 6 shows an isometric view of a second embodiment of the device according to the present invention;

FIG. 7 shows a reverse isometric view of the embodiment of the device shown in FIG. 6;

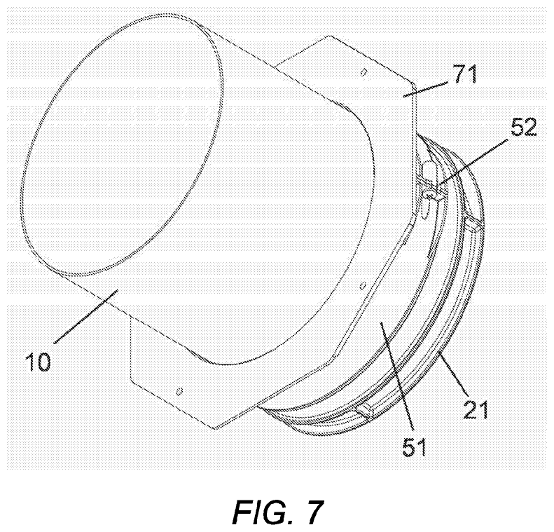

FIG. 8 shows an exploded isometric view of the embodiment shown in FIG. 6;

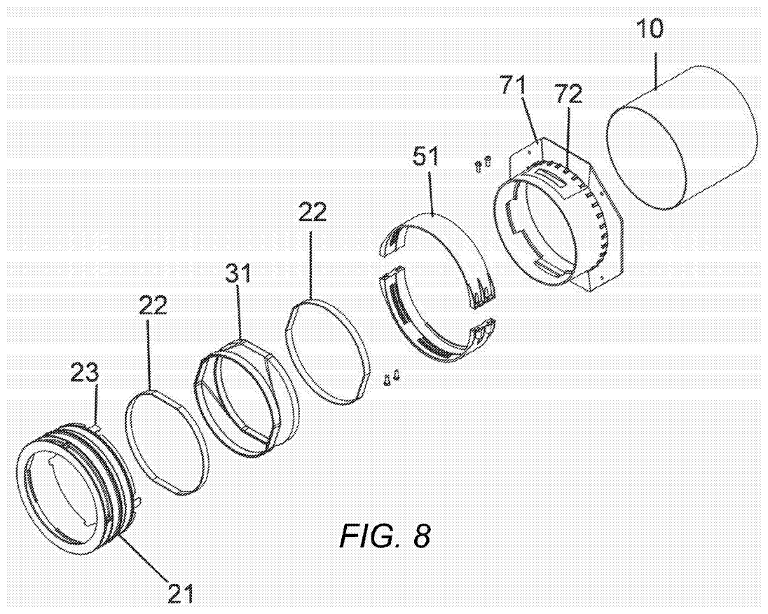

FIG. 9 shows a reverse exploded isometric view of the embodiment shown in FIG. 6; and

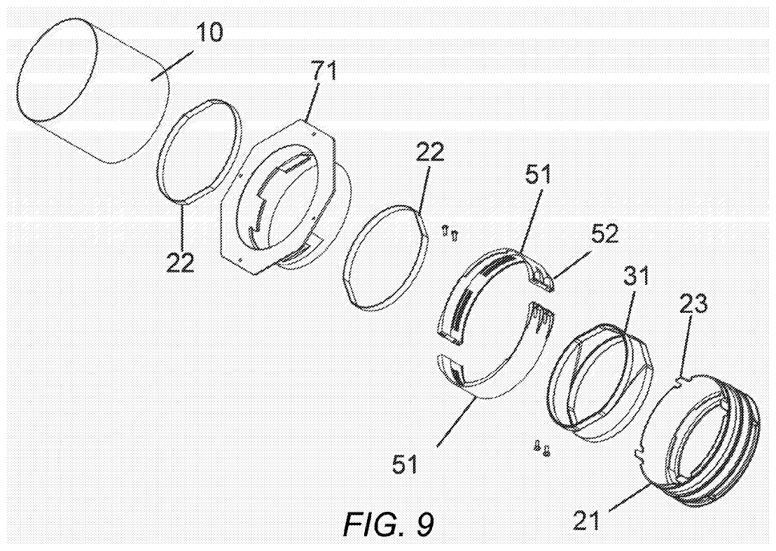

FIG. 10 show a side sectional view and a side view respectively of the embodiment shown in FIG. 6.

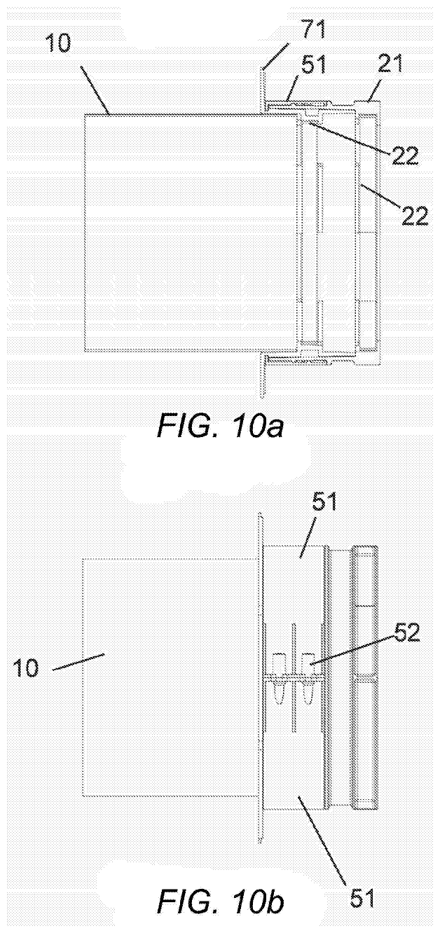

### DETAILED DESCRIPTION OF FIGURES

With reference to the figures there are shown embodiments of the device according to the present invention, generally comprising two opposed faces A,B, and an intermediate passage defining an axis C for passage of elongate objects, wherein the passage forms part of a hole through two sides of a structure D, and a displaceable barrier 3,31 is located between the faces; and wherein the barrier is rotated about the axis to change the diameter of the passage.

In particular reference to the pictured embodiment the embodiment comprises a base plate 7, which base plate is secured to the wall structure around a pipe 10, using screws, and in use intumescent sealant.

The base plate 7 surrounds a protruding pipe 10 which protruding through a hole in a wall structure D, provides the passage through the wall for the cabling 100.

A collar 6 surrounds the pipe and extends orthogonal the base plate 7 along the axis C.

An annular lock part 4 is coaxially located outside the collar 6, and outside this coaxially is a cover part 5. The lock part includes two tab handles which extend orthogonal the axial surface of the lock part, and through hole sin the cover part 5.

Inside the collar is the barrier 3, which is formed in a robust fire-resistant Kevlar® material or similar.

The barrier is cylindrical and includes structural strengthening rings 12 at either of its ends. The ring on the end nearest the outer face B of the embodiment is held in a rotatable front housing 2.

The ring on the distal end of the barrier is locked to the collar, such that when rotating the front housing the barrier will twist helically, so as to narrow or enlarge the passage.

The lock part has multiple fingers extending upwards from the base plate in use, and is arranged to move axially. The fingers engage catch means on the lower face of the front housing when the lock part is furthest away from the base plate.

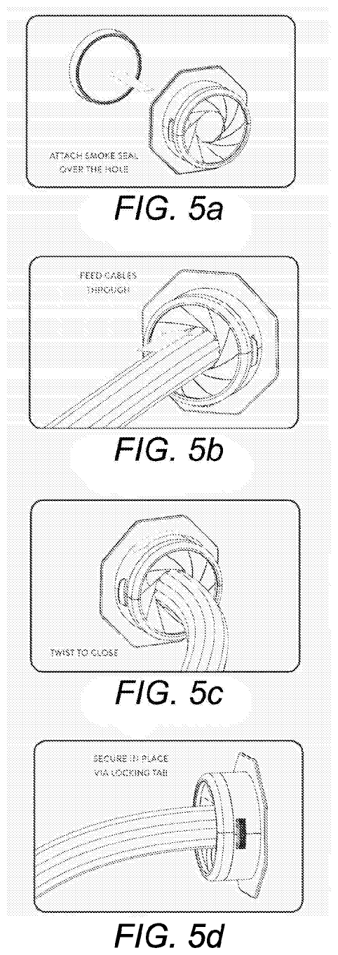

In this way the tabs are used to disengage the locked position by pushing the lock part away from the front housing and towards the base plate, as shown in FIG. 5c, so as to allow rotation and twisting of the barrier around the cabling 100 to form a constricted passage around them.

The rotation is then locked by pulling up the tabs so as to engage them into the catch means of the front housing 2.

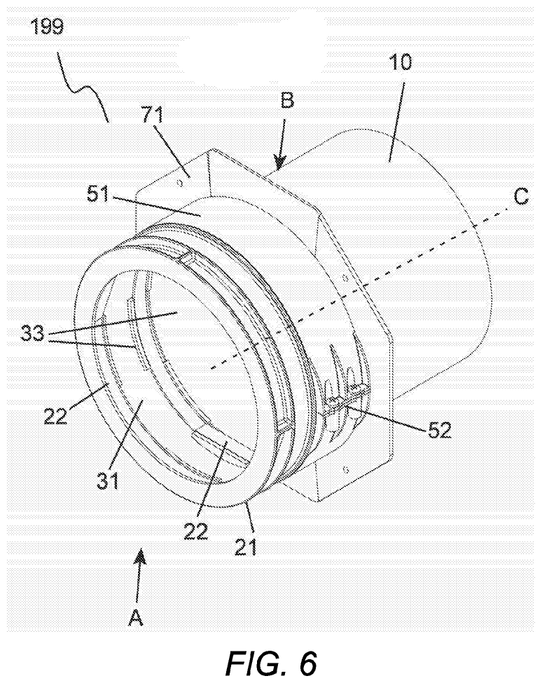

With reference to the embodiment 199 shown in FIG. 6 the embodiment comprises a displaceable barrier 31 held in a front housing 21 by a displaceable stainless steel ring 22, and a base plate 71 with a second displaceable stainless steel ring 22.

The rings 22 have flattened segments on opposing sides of the circumference, which are gripped by the base plate between opposing castellated tabs holding against the edges of the ring, and by flats 33 within the front housing 21. In this way the front housing prevents rotation of the ring as the resilient ring cannot displace from the flats and holds the barrier against the inner face of the front housing.

In this way the front housing may be rotated to rotate one ring and one end of the barrier. The front housing further includes four circumferentially spaced apart projections 23 which seat against studs 72 on the base of the bas plate 71.

An annular lock part 51 is placed around the front housing and base plate when engaged so as to allow for the front housing to move axially and allow disengagement of the projections and studs, and rotation. The annular lock part is formed of two semicircular bands and has two sets of two screws joining it together.

The invention has been described by way of examples only and it will be appreciated that variation may be made to the above-mentioned embodiments without departing from the scope of invention as defined by the claims, in particular but not solely combination of features of described embodiments.

1. A firestop device comprising two opposed faces, and an intermediate passage defining an axis for passage of elongate objects, wherein the passage forms part of a hole through two sides of a structure, and a displaceable barrier is located between the faces; and wherein the barrier is rotated about the axis to change the diameter of the passage.

2. A device according to claim 1 wherein the barrier comprises fabric.

3. A device according to claim 2 wherein the fabric comprises Kevlar® or similar fire-resistant material.

4. A device according to claim 1, wherein the barrier comprises a cylindrical tube.

5. A device according to claim 4 wherein one end of the tube is connected to a rotatable front housing, and a distal end is connected to the structure.

6. A device according to claim 1, further comprising a lock part to engage a catch means and prevent rotation.

7. A device according to claim 6 wherein the lock part disengages the catch means when moved axially.

8. A device according to claim 1, wherein both faces of the device are located to one side of a structure.
